(19) United States
(12) Patent Application Publication
(10) Pub. No.: US 2024/0315162 A1
(43) Pub. Date: Sep. 26, 2024

(54) AUTONOMOUS VEHICLE IMPLEMENT CONTROL

(71) Applicant: Blue White Robotics Ltd, Tel Aviv (IL)

(72) Inventors: Aviram SHMUELI, Modi'in (IL); Alon ASCHER, Tel Aviv (IL); Ben ALFI, Tel Aviv (IL); Rony SHEMA, Nahshon (IL); Yinon HARARI, Pardes Hana-Karkur (IL)

(73) Assignee: Blue White Robotics Ltd, Tel Aviv (IL)

(21) Appl. No.: 18/126,444

(22) Filed: Mar. 26, 2023

(51) Int. Cl. A01B 79/00; G05D 1/02

(52) U.S. Cl. CPC A01B 79/005

(57) ABSTRACT

Method, device and computer program product for controlling an autonomous vehicle coupled to an implement, the method comprising: by at least one processing circuitry of a device adapted to be in communication with an autonomous vehicle coupled to an implement, executing code for: receiving sensory data relating to the implement acquired by at least one sensor deployed in an environment of the implement and configured for operating during working of the implement in the environment; determining, based on analyzing the sensory data, at least one of: instructions to modify a motion vector of the autonomous vehicle, and instructions to perform an actuation operation on the implement by the autonomous vehicle; generating at least one control command encoding the instructions; and communicating the at least one control command to the autonomous vehicle, wherein the autonomous vehicle applying the instructions in response to the at least one control command.

### BACKGROUND

Some embodiments described in the present disclosure relate to automotive control and, more specifically, but not exclusively, to autonomous vehicle implement control.

The field of agriculture and/or farming revolves mainly around cultivation and care of soil, growth of crops, livestock raising and/or the like. It includes the preparation of plant and animal products for people to use and their distribution to markets. Agriculture provides most of the world's food and fabrics, such as for example cotton, wool, leather, and/or likewise agricultural products, as well as wood for construction and paper products.

With the world population ever growing and human life expectancy consistently on the rise, there is a constant and urging need for technological improvements in the art of agriculture and/or farming that would increase and/or ameliorate produce and/or yield as well as reduce resources invested such as labor costs and/or the like, in order to meet outgrowing demand and managing provision for bare necessities of humanity and supporting its sustainable existence.

### SUMMARY

It is an object of the present disclosure to describe a system and a method for autonomous vehicle implement control.

The foregoing and other objects are achieved by the features of the independent claims. Further implementation forms are apparent from the dependent claims, the description and the figures.

According to an aspect of the disclosed subject matter there is provided a method of controlling an autonomous vehicle coupled to an implement adapted for agricultural use, the method comprising: by at least one processing circuitry of a device adapted to be in communication with an autonomous vehicle coupled to an implement, executing code for:

receiving sensory data relating to the implement acquired by at least one sensor deployed in an environment of the implement and configured for operating during working of the implement in the environment; determining, based on analyzing the sensory data, at least one of: instructions to modify a motion vector of the autonomous vehicle, and instructions to perform an actuation operation on the implement by the autonomous vehicle; generating at least one control command encoding the instructions; and communicating the at least one control command to the autonomous vehicle, wherein the autonomous vehicle applying the instructions in response to the at least one control command.

Optionally, the analyzing the sensory data comprising determining at least one event related to the implement and at least one action required in response to the at least one event.

Optionally, the at least one sensor being selected from the group consisting of: a revolutions per minute sensor; a speed sensor; a moment measurement sensor; a heat sensor; an orientation sensor; a motion sensor; a pressure sensor; a volume sensor; an electronics load sensor; an electromagnetic imaging sensor; an acoustic imaging sensor.

Optionally, the instructions to modify the motion vector of the autonomous vehicle comprising at least one action by a controller of the autonomous vehicle selected from: start driving the autonomous vehicle; accelerate engine of the autonomous vehicle; decelerate engine of the autonomous vehicle; switch direction of motion of the autonomous vehicle to at least one of forwards and backwards; turn the autonomous vehicle to a specified direction; operate a braking system of the vehicle; stop the autonomous vehicle at a specified location in the environment; and move the autonomous vehicle in a specified trajectory.

Optionally, the instructions to perform the actuation operation on the implement by the autonomous vehicle comprising at least one member selected from: engage a power take off between the autonomous vehicle and the implement; disengage a power take off between the autonomous vehicle and the implement; lower a three-point hitch adapter coupling the autonomous vehicle and the implement to a specified height relative to the autonomous vehicle; raise a three-point hitch adapter coupling the autonomous vehicle and the implement to a specified height relative to the vehicle; decrease a revolutions per minute energy level of the implement; increase a revolutions per minute energy level of the implement; modify at least one of a direction, a flow, and a pressure of at least one of a plurality of hydraulics channels connected to the implement; and operate an electric energy supply to the implement.

Optionally, the method further comprising performing, by the at least one processing circuitry, executing code for: receiving, over a communication channel established between the device and the autonomous vehicle, operational data relating to operation of the autonomous vehicle during working of the implement in the environment; and, analyzing the operational data further to the sensory data in determining the at least one of the instructions.

Optionally, the determining the at least one of the instructions being performed in compliance with a specification of the implement.

Optionally, the method further comprising performing, by the at least one processing circuitry, executing code for: identifying a type of at least one of the autonomous vehicle and the implement; and, configuring the analyzing of the sensory data and the determining the at least one of the instructions in accordance with the type identified.

Optionally, the method further comprising performing, by the at least one processing circuitry, executing code for: receiving at least one parameter value of at least one configurable parameter of the implement; and, setting the at least one configurable parameter respective of the at least one parameter value received, wherein the determining the at least one of the instructions being performed in accordance with the at least one parameter value set for the at least one configurable parameter.

Optionally, the method further comprising performing, by the at least one processing circuitry, executing code for: determining, based on analyzing the sensory data, whether at least one alert condition being met; and, outputting at least one respective alert to a user in response to determining the at least one alert condition being met.

Optionally, the autonomous vehicle is an agricultural vehicle.

Optionally, the autonomous vehicle is a tractor.

Optionally, the implement is an agricultural implement to be connected to a tractor.

Optionally, a plurality of implements comprising the implement are coupled to the autonomous vehicle and connected to one another into a single working unit.

According to another aspect of the disclosed subject matter there is provided a device for controlling an autonomous vehicle coupled to an implement adapted for agricultural use, comprising: a communication interface adapted for communication with an autonomous vehicle coupled to an implement; at least one processing circuitry adapted to execute code for: receiving sensory data relating to the implement acquired by at least one sensor deployed in an environment of the implement and configured for operating during working of the implement in the environment; determining, based on analyzing the sensory data, at least one of: instructions to modify a motion vector of the autonomous vehicle, and instructions to perform an actuation operation on the implement by the autonomous vehicle; generating at least one control command encoding the instructions; and communicating the at least one control command to the autonomous vehicle applying the instructions in response to the at vehicle, wherein the autonomous least one control command.

Optionally, the device further comprising an implement mount for mounting the device on the implement.

Optionally, the device further comprising a plurality of brackets for fitting the device to different models of autonomous vehicles.

Optionally, the device further comprising a data bus adapted for connection to and receipt of data from the implement.

Optionally, the device further comprising a plurality of relays adapted for communication with a low-level controller of the autonomous vehicle.

According to another aspect of the disclosed subject matter there is provided a computer program product for controlling an autonomous vehicle coupled to an implement adapted for agricultural use, comprising: a non-transitory computer readable storage medium; program instructions for executing, by a processing circuitry of a device adapted to be in communication with an autonomous vehicle coupled to an implement: receiving sensory data relating to the implement acquired by at least one sensor deployed in an environment of the implement and configured for operating during working of the implement in the environment; determining, based on analyzing the sensory data, at least one of: instructions to modify a motion vector of the autonomous vehicle, and instructions to perform an actuation operation on the implement by the autonomous vehicle; generating at least one control command encoding the instructions; and communicating the at least one control command to the autonomous vehicle, wherein the autonomous vehicle applying the instructions in response to the at least one control command.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which embodiments. Although methods and materials similar or equivalent to those described herein can be used in the practice or testing of embodiments, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments are herein described, by way of example only, with reference to the accompanying drawings. With specific reference now to the drawings in detail, it is stressed that the particulars shown are by way of example and for purposes of illustrative discussion of embodiments. In this regard, the description taken with the drawings makes apparent to those skilled in the art how embodiments may be practiced.

In the drawings:

FIG. 1 is a schematic block diagram of an exemplary system architecture for autonomous vehicle implement control, according to some embodiments;

FIG. 2 is a schematic block diagram of an exemplary apparatus for autonomous vehicle implement control, according to some embodiments;

FIG. 3 is a schematic block diagram of an exemplary low level control wiring architecture for autonomous vehicle implement control, according to some embodiments;

FIG. 4 is a flowchart schematically representing an optional flow of operations for autonomous vehicle implement control, according to some embodiments; and

FIG. 5 is a sequence diagram of an optional flow of operations in an exemplary illustrative use case of utilizing autonomous vehicle implement control, according to some embodiments.

### DETAILED DESCRIPTION

Some embodiments described in the present disclosure relate to automotive control and, more specifically, but not exclusively, to autonomous vehicle implement control.

The practice of agriculture and/or farming and related processes may typically involve various repetitive tasks and/or strenuous actions that may require exertion of great physical force. In order to facilitate and streamline such activities and improve overall performance and/or yield, agricultural implements and/or vehicles may advantageously be utilized for such and/or similar purposes.

Agricultural implements are tools and machines such as plows, harrows, seeders, mowers, irrigation systems, and other likewise equipment used for performing various operations and works in farming, as well as on other industries such as construction and forestry, often in conjunction with tractors and/or other vehicles to which the implements can be attached and thus utilize for driving, actuation, and/or the like, whether exclusively and/or jointly with a power supply and/or other likewise functionality of an implement at hand. In recent years, there has been a growing demand for more advanced and efficient agricultural implements, as farmers seek to increase productivity and profitability.

Attachment of an implement such as, for example, a mower and/or the like to a vehicle adapted for connecting thereto implements of this sort such as, for example, a tractor and/or the like, involves connecting the implement to the power, hydraulic, and/or electrical systems of the vehicle. Aspects of such attachment of an implement to a vehicle may include, for example, at least one power take-off (PTO) mechanism, one or more hydraulics ports, at least one electrical actuation component, at least one three-point hitch adapter, at least one drawbar, at least one data communication bus such as, for example, an ISOBUS connector in accordance with the ISO 11783 protocol as set by the International Organization for Standardization (ISO), and/or the like.

As used herein, the term “power take-off” refers to a mechanical device that transfers power from the engine of the vehicle to the implement. It may be used to power implements such as mowers, pumps, generators, and/or the like.

As used herein, the term “hydraulic ports” refers to connection means that are used to connect the hydraulic system of the implement to that of the vehicle. This may allow the implement to use the power of the vehicle to operate its own hydraulic functions, such as for example raising and lowering and/or the like.

As used herein, the term “electrical actuation” refers to a component that is used to control functions of the implement, such as opening and closing a valve, activating a motor, and/or the like. This may typically be done through a control box and/or a likewise interface in a cabin space of the vehicle, e.g., at a seat of an operator and/or the like.

As used herein, the term “three-point hitch” refers to a type of attachment system used on tractors and/or the like to connect implements such as plows, cultivators, mowers, and/or the like. It consists of three points of attachment: the top link, which connects the implement to a lift arm of a tractor; the lower lift arms, which support the implement; and the center link, which helps control a depth of the implement.

As used herein, the term “drawbar” also used interchangeably with “haulage” refers to a type of attachment system used on tractors and/or the like to connect implements such as trailers, wagons, mowers, and/or the like. The implement may be connected to the tractor via a pin or ball hitch, and power of the tractor may be transferred to the implement through the drawbar.

As used herein, the term “ISO bus” refers to an electronic communication system that allows implements to communicate with an electronic control system of the vehicle. It may allow for the implement to be controlled and monitored by a computer and/or likewise automated control device of the vehicle, and for data to be collected and processed by the implement.

Autonomous vehicles are vehicles that are capable of operating without a human driver, using sensors, cameras, and other technologies to navigate their surroundings and perform various tasks. Implements, such as plows, harrows, seeders, and other agricultural equipment, are often attached to tractors and other vehicles to perform various tasks in farming and other industries. Use of autonomous vehicles thus can potentially lead to more efficient and productive farming operations, as well as improved safety and reduced labor costs, eliminating or at the least reducing to a minimum any and all human intervention.

In some embodiments, an apparatus such as described and referred to herein as “control module”, “implement module”, “implement control module” and/or the like, may be adapted to be connected to and/or be in communication with an autonomous vehicle to which an implement may be coupled. The implement control module may be adapted when being in an operative mode to receive sensory data, which may include sensory data acquired by at least one sensor deployed in an environment of the implement and/or operating during working of the implement in the environment. The implement control module may be further adapted to perform analysis of the sensory data to determine at least one action to be performed by the autonomous vehicle. The implement control module may be yet further adapted to generate at least one control command encoding instructions to perform the at least one action, and to communicate the at least one control command to the autonomous vehicle, wherein the autonomous vehicle applies the instructions in response to the at least one command, whereby performing the at least one action.

The sensory data may be received and/or originate from one or more sensors and/or sensor types, which may include, for example, revolutions per minute (RPM) sensor(s), speed sensor(s), moment measurement sensor(s), heat sensor(s), orientation sensor(s), motion sensor(s), pressure sensor(s), volume sensor(s), electronics load sensor(s), electromagnetic imaging sensor(s), e.g., camera(s), light detection and ranging (LiDAR) sensor(s), radio detection and ranging (RADAR) sensor(s), and/or the like, acoustic imaging sensor(s), and/or the like. Optionally the sensory data may be and/or include data acquired by one or more sensors of the autonomous vehicle, such as for example, sensor(s) attached to, mounted on, integrated into (e.g., built-in and/or the like), and/or otherwise provided with the autonomous vehicle.

The instructions may include instructions to modify a motion vector of the autonomous vehicle, such as for example start driving the autonomous vehicle, accelerate or decelerate engine, switch motion direction between forwards and backwards, turn left or right, operate brakes, stop at specified point(s), move along specified path(s), and/or the like. The instructions may be directed to a controller of the autonomous vehicle, which may be of a high-level control (HLC) type, a low-level control (LLC) type, and/or the like.

Additionally or alternatively, the instructions may include instructions to perform an actuation operation on the implement by the autonomous vehicle such as, for example, engage or disengage power take off, lower or raise three-point hitch adapter to specified altitude(s), decrease or increase revolutions per minute (RPM) energy level of the implement, modify at least one of a direction (e.g., forwards or backwards), a flow rate (e.g., volumetric flow rate, for example, an amount of litters per minute, mass flow rate, and/or the like), and a pressure magnitude (e.g., an amount of pound force for square inch (PSI) and/or the like) of at least one of a plurality of hydraulics channels connected to the implement, operate an electric energy supply to the implement, and/or the like. Optionally the instructions to perform an actuation operation may include instructions for stopping the implement actuation altogether, for example, based on analysis of sensory data received also from sensor(s) of the autonomous tractor and/or the like.

In some embodiments, the implement control module may be adapted to be mounted on an implement coupled to an autonomous vehicle, for example by using an implement mount and/or the like coupled to and/or otherwise provided with the implement control module. Additionally or alternatively, the implement control module may be adapted to be connected to an autonomous vehicle to which an implement may be coupled. Optionally the implement control module may be encased by and/or otherwise provided with a housing, which may comprise a plurality of brackets to allow fitting thereof to different models of autonomous vehicles that may be employed for driving and/or working the implement, and/or to different implements and/or implement models, and/or the like. In some embodiments, installation of the implement control module for controlling an implement coupled to an autonomous vehicle may be onboard the implement itself, the autonomous vehicle (e.g., an autonomous tractor of any type), and/or the like, and may include a calibration phase to align all functionality and/or a portion thereof.

The implement control module may optionally be adapted to be connected to and/or be in communication with the implement for receiving input therefrom. Such input may include, for example, sensory data generated by and/or otherwise originating at the implement and/or one or more components included in and/or related to the implement, e.g., data gathered by one or more sensors that may be mounted on-board, integrated into (i.e., built-in and/or the like), and/or otherwise coupled to the implement. Additionally or alternatively, the input received from the implement may include operational notifications such as error messages, alerts, self-diagnostics, and/or the like generated by a controller and/or operational system of the implement.

The implement control module may optionally be adapted to receive input from the autonomous vehicle, such as for example over a communication channel established therewith, via a communication bus, a network interface, and/or any likewise data transfer connection of the autonomous vehicle and/or the implement. Such input may include, for example, operational data relating to operation of the autonomous vehicle during working of the implement in the environment and/or the like. The operational data may describe and/or relate to a state of the autonomous vehicle, such as for example telemetry data, mode of operation (e.g., manual, automatic, semi-automatic, and/or the like), motion and/or actuation limits, level of pressure, heat, liquid status and/or the like. Optionally, the implement control module may analyze the operational data further to the sensory data and determine the at least one action to be performed by the autonomous vehicle in accordance with the operational data as well.

In some embodiments, an implement specification such as may be available from and/or provided by an implement manufacturer, may be used for a respective implement by the implement control module, whether in analysis of sensory data related to the implement and/or working environment thereof, and/or in determination of control commands for performing actions and/or action series by an autonomous vehicle to which the implement being attached for controlling operation of the implement. The actions to be performed by the autonomous vehicle may be determined in compliance with the specification of the implement. This way, proper functioning and/or optimal throughput of the implement may be attained. Specifications of different implement types and/or models may be loaded onto and/or retrieved by the implement control module from a local and/or remote storage, e.g., cloud service and/or the like. The loading and/or retrieval of implement specification(s) may be performed periodically, on-demand, via push updating, and/or the like.

In some embodiments, the implement control module may be adapted to automatically identify a type and/or model of the autonomous vehicle and/or the implement, and accordingly configure a respective control logic for operating the implement, thereby adapting analysis of related sensory data and/or determination of control commands to the autonomous vehicle for operating the implement to particular characteristics of specific implement and/or autonomous vehicle utilized, and/or to specific task to be thus performed. Additionally or alternatively, the type and/or model of the autonomous vehicle and/or the implement, details of a task at hand, and/or the like, may be manually set by a user and/or operator.

In some embodiments, an implement coupled to an autonomous vehicle may be associated with one or more configurable parameters, such as for example, a working height above ground, height tolerance, revolutions per minute (RPM) limits, hitch motion rate, workflow, abnormal procedures, and/or the like. Optionally at least one parameter value of respective configurable parameter(s) of the implement may be received and set therefor by the implement control module, where analysis of sensory data and/or determination of control commands for operating the implement may be configured in accordance with the parameter value(s) set for the configurable parameter(s).

In some embodiments, analysis of sensory data related to an implement and/or operational data of an autonomous vehicle to which the implement being attached, determination of control commands for operating the implement, and/or other likewise logical tasks performed by the implement control module, may be event driven and/or reactive. An event driven status determination for the implement and/or autonomous vehicle by the implement control module may be advantageous over mere reliance on continuous telemetry data that may be transferred from the implement and may be thus strictly passive. One illustrative exemplary use case may be a reply data and/or output from the implement that may occur in response to a specific situation, error, breakage and/or the like of the implement and/or a logical control system thereof, which may trigger an alert that user action and/or other likewise intervention may be required, where the alert may be issued by the implement directly and/or otherwise via respective output thereof.

The implement control module may be adapted to analyze received input such as sensory data related to the implement and/or operational data of the autonomous vehicle, and accordingly determine at least one event related to the implement and/or working environment thereof, which may include for example events related to the autonomous vehicle itself and/or other objects in the environment such as plants, people, equipment, and/or the like. Optionally one or more control commands for operating the implement may be determined by the implement control module in response to events and/or event series detected. Additionally or alternatively, the implement control module may be adapted to determine, based on analyzing input received, whether one or more alert conditions being met, and accordingly output respective alert(s) to a user and/or operator in response to such determination in the affirmative.

An autonomous vehicle utilized in conjunction with the implement control module according to some embodiments of the disclosed subject matter may optionally be an agricultural vehicle, such as for example, a tractor and/or the like.

Additionally or alternatively, an implement utilized in conjunction with the implement control module according to some embodiments of the disclosed subject matter may optionally be an agricultural implement, such as for example, a mower and/or the like, adapted to be connected to an agricultural vehicle, such as a tractor and/or the like.

Optionally an implement controlled by the implement control module in accordance with the disclosed subject matter may be connected to the autonomous vehicle as one implement in a series of different implements, one after the other in a row, all connected together physically to form a single working unit with several joints, such as for example, connecting a duster in front of a mover and/or the like, all of which being connected to one autonomous vehicle (e.g. a tractor).

Optionally the implement control module may allow for selective handover to manual operation of an implement and/or autonomous vehicle to which the implement being coupled, e.g., by a driver, user, operator, and/or the like, and vice versa, i.e., resumption of autonomous operation by the implement control module.

It will be appreciated that the implement control module according to some embodiments of the disclosed subject matter may be utilized advantageously in conjunction with any manual implement for transforming thereof to an autonomously operated and controlled implement.

The disclosed subject matter provides for an adaptive, one-fits-all implement control module for communicating with an autonomous vehicle, e.g., a heavy machinery and/or power tool such as a tractor and/or the like, for controlling the heavy machinery based on at least sensory data related to an implement coupled to the heavy machinery and optionally adapted for use in agriculture (e.g., data depicting state and/or status of the implement and/or surroundings), where the implement control module may be suitable for multiple types of agriculture implements and/or multiple types of heavy machineries, and/or for serving various autonomous heavy machinery agriculture missions and/or likewise functions.

It will be appreciated that by utilizing the implement control module according to some embodiments of the disclosed subject matter, autonomous operations of an implement and/or an autonomous vehicle to which the implement being attached may include and/or span over an entire state and/or status space of the implement, autonomous vehicle, and/or combination thereof, which in turn may be wholly and/or partially inter-connected and/or affecting each other during respective agricultural and/or likewise missions and/or operations being carried out.

Before explaining at least one embodiment in detail, it is to be understood that embodiments are not necessarily limited in its application to the details of construction and the arrangement of the components and/or methods set forth in the following description and/or illustrated in the drawings and/or the Examples. Implementations described herein are capable of other embodiments or of being practiced or carried out in various ways.

Embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays ((FPGA), or programmable logic arrays (PLA) may execute the computer readable program instructions by utilizing state information of the computer readable program instructions to personalize the electronic circuitry, in order to perform aspects of embodiments.

Aspects of embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

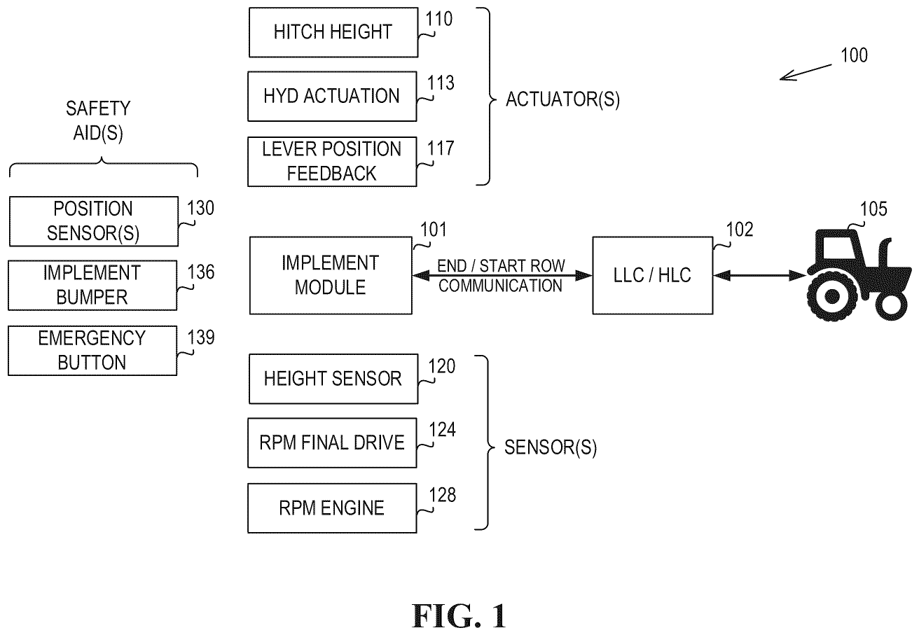

Reference is now made to FIG. 1 which is a schematic block diagram of an exemplary system architecture for autonomous vehicle implement control, according to some embodiments.

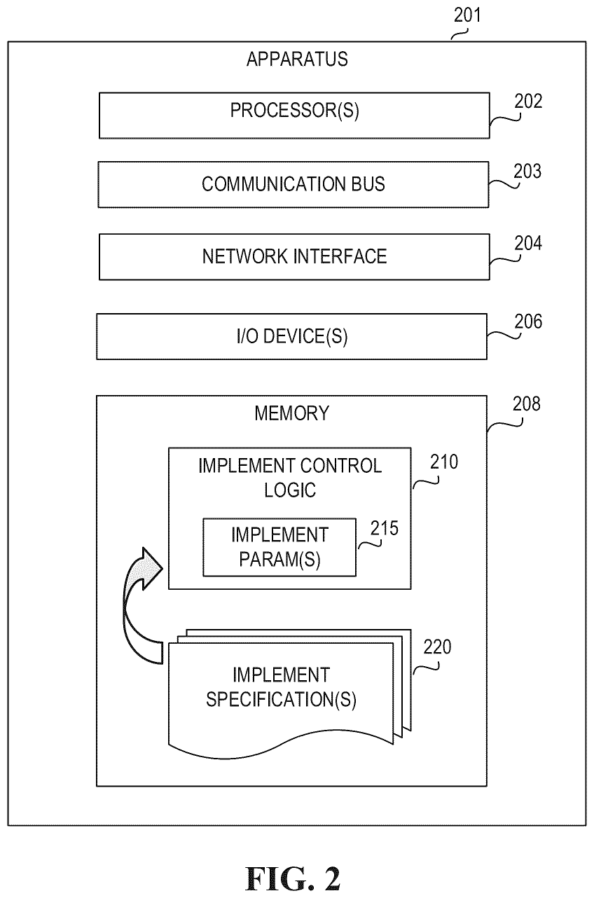

A system architecture for autonomous vehicle implement control such as 100 of FIG. 1 may comprise an implement module such as 101 which may be adapted to communicate with an autonomous vehicle such as 105, via one or more high-level control and/or low-level control (LLC/HLC) components such as 102, as may be provided for the autonomous vehicle 105. The autonomous vehicle 105 may be a heavy machinery and/or a likewise power tool adapted for use in agriculture and/or likewise missions, such as a tractor and/or the like. The autonomous vehicle 105 may be adapted for coupling thereto an implement (not shown), e.g., an implement adapted for use in agriculture and/or likewise missions, such as a mower and/or the like. The implement module 101 may be an apparatus such as 201 of FIG. 2 as described in further detail herein.

The architecture 100 may comprise one or more actuators, such as actuator(s) 110, 113, and 117 for maneuvering and/or performing actuation operations on at least one mechanical, electrical, hydraulic, pneumatical and/or any likewise mechanism of the autonomous vehicle 105 for operating an implement coupled to the autonomous vehicle 105, such as a mower and/or other likewise agricultural implement. Such actuator(s) may comprise, for example, actuator(s) for hitch height manipulation such as 110, actuator(s) for hydraulics actuation such as 113, actuator(s) for three-point lever position feedback such as 117, and/or the like.

The architecture 100 may comprise one or more sensors, such as sensor(s) 120, 124, and 128 for acquiring sensory data related to an implement coupled to the autonomous vehicle 105, in particular during and/or in relation to operation of the implement. Such sensor(s) may comprise, for example, height sensor(s) such as 120, sensor(s) for detecting, measuring and/or monitoring of revolutions per minute (RPM) of a final drive such as 124, and/or of any likewise transmission components of the autonomous vehicle 105 and/or of an implement coupled thereto, sensor(s) for detecting, measuring and/or monitoring of revolutions per minute (RPM) of an engine, motor, and/or the like such as 128, and/or of any likewise drive components of the autonomous vehicle 105, and/or any other likewise sensor(s) for obtaining information related to the implement and/or operation thereof in a working environment.

The architecture 100 may comprise one or more safety aids and/or accessories, such as safety aid(s) 130, 136, and 139 for detecting and/or protecting against potential hazards to and/or from an implement coupled to the autonomous vehicle 105 and/or its operation of the implement. Such safety aid(s) may comprise, for example, position sensor(s) such as 130 for determining positioning of the implement relative to the autonomous vehicle 105 and/or other likewise reference point, an implement bumper such as 136 for providing protection to the autonomous vehicle 105 and/or for assisting stabilization of an implement attached to the autonomous vehicle 105 during operation thereof by the autonomous vehicle 105, an emergency button such as 139 for immediate shutdown and/or otherwise stopping operation of an implement attached to the autonomous vehicle 105, and/or any other likewise safety aids and/or accessories for reducing and/or mitigating risks involved in operation of an implement by the autonomous vehicle 105.

The implement control module 101 may be adapted to receive as input information related to an implement attached to the autonomous vehicle 105 and/or operation of the implement by the autonomous vehicle 105. Such information may comprise, for example, sensory data originating from sensor(s) such as 120, 124, 128 and/or from position sensor(s) 130 and/or likewise safety aid(s) where sensory data being acquired, operational data relating to the autonomous vehicle 105, e.g., a magnitude and/or direction of a motion vector thereof and/or the like, settings of respective values for configurable parameters of the implement and/or mission at hand, type and/or model of the implement and/or the autonomous vehicle 105, implement specification(s) for ensuring compliance of operation of the implement by the autonomous vehicle 105 to a corresponding specification of the implement, and/or the like.

The implement control module 101 may be adapted to analyze the input received and determine actions to be performed by the autonomous vehicle 105 on an implement coupled thereto, such as for example operations effected via one or more of the actuator(s) 120, 124, and 128, and/or via the LLC/HLC component(s) 102 being adapted for controlling aspects of the autonomous vehicle 105 otherwise affecting operation of the implement, such as for example, operations aimed at modifying a motion vector of the autonomous vehicle 105, such as speed change, direction shift, reorientation, and/or the like. The implement control module 101 may determine to invoke one or more safety aid(s) such as the implement bumper 136, emergency button 139, and/or the like in appropriate circumstances where potential and/or imminent danger relating to the implement and/or operation thereof by the autonomous vehicle 105 being identified in and/or otherwise inferred from the input received, e.g., from the position sensor(s) 130 and/or the like.

The implement control module 101 may generate one or more control commands encoding instructions for the autonomous vehicle 105 to perform the actions determined and communicate the control command(s) generated to the LLC/HLC component(s) 102, actuator(s), safety aid(s), and/or likewise respective elements of an architecture such as 100 for autonomous vehicle implement control as disclosed herein. The implement control module 101 may use one or more implement relays for communication with the LLC/HLC component(s) 102 and/or other elements of the architecture 100.

In some embodiments, a working environment may be a field where plants of crops grown may be planted, sown, and/or otherwise cultivated in regular form, such as for example, arranged successively in each of multiple rows stretching along parallel lines (i.e., in a raster-like format), concentric circles, and/or the like. An operation of an implement by the autonomous vehicle 105 may be with relation to each of the respective rows and/or locations where an end and/or start of a row being at, such as illustrated on FIG. 1 herein and as further described with reference to FIG. herein.

It will be appreciated that the actuator(s) 110, 113, and 117, the sensor(s) 120, 124, and 128, and/or the safety aid(s) 130, 136, and 139 are merely described on FIG. 1 herein by way of illustrative and non-limiting examples, and that other additional and/or alternative actuator(s), sensor(s), and/or safety aid(s) may be similarly utilized by and/or in conjunction with the disclosed subject matter as described and illustrated herein.

Reference is now made to FIG. 2 which is a schematic block diagram of an exemplary apparatus for autonomous vehicle implement control, according to some embodiments.

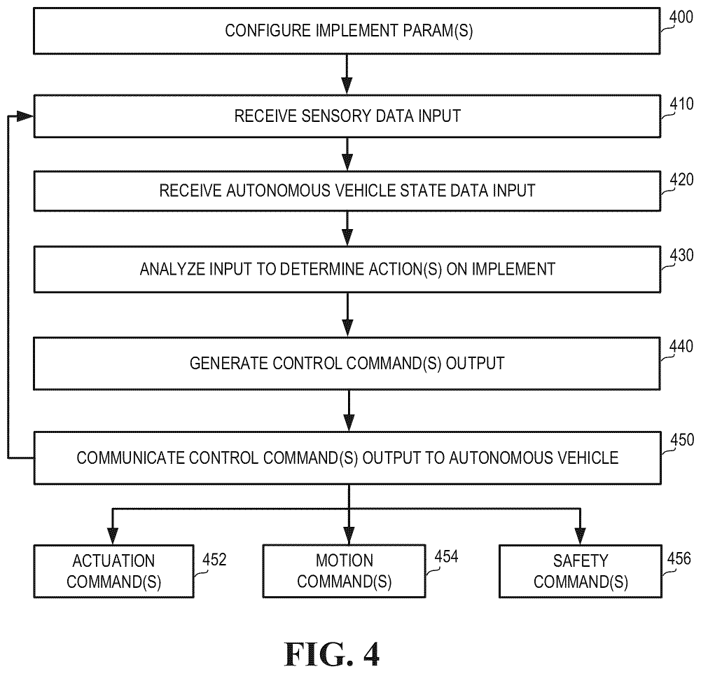

An apparatus for autonomous vehicle implement control such as 201 may be implemented as, for example, a standalone unit, a server, a computing cloud, a desktop computer, a laptop computer, a tablet computer, a smart phone, a wearable computer, a mainframe computer, a quantum computer, and/or the like. Alternatively or additionally, the apparatus 201 may be implemented as, for example, a client terminal, a thin client, and/or the like, adapted to exchange data with another apparatus such as of the aforementioned. The apparatus 201 may be implemented as a customized unit that includes locally stored software and/or hardware that perform one or more of the acts described with reference to FIG. 4 herein. Alternatively or additionally, the apparatus 201 may be implemented as code instructions loaded on an existing computing device. Alternatively or additionally, the apparatus 201 may be implemented as hardware and/or code instructions (e.g., an accelerator card) installed and/or integrated within an existing computing device.

The apparatus 201 may comprise one or more processors such as 202, which may be implemented as, for example, a central processing unit(s) (CPU), a graphics processing unit(s) (GPU), field programmable gate array(s) (FPGA), digital signal processor(s) (DSP), and application specific integrated circuit(s) (ASIC). The processor(s) 202 may include one or more processors (homogenous or heterogeneous), which may be arranged for parallel processing, as clusters and/or as one or more multi core processing units.

In some embodiments, the apparatus 201 may comprise a communication bus such as 203, which may be implemented for example as a serial communication bus using single data line to transfer data, a parallel communication bus using multiple data lines, a central bus, a point-to-point connection bus, a wireless communication bus using wireless communication protocol such as for example Wi-Fi, Bluetooth, or Zigbee, and/or the like, a hybrid bus, and/or the like. Optionally the communication bus may be implemented as a Controller Area Network (CAN) bus and/or likewise vehicle communication protocol, such as the ISO 11783 (ISO Bus) and/or the like.

In some embodiments, in addition to or alternative of the communication bus 203, the apparatus 201 may comprise a network interface such as 204 for transmission and/or receipt of data over a network (not shown) and/or other suitable communication channel. The network may be any type of data network, for example, a local area network (LAN), a wireless LAN, a wide area network (WAN), or the connection may be made to an external computer, for example through the Internet using an Internet Service Provider (ISP) and/or any other type of computer network. The wireless LAN may use one or more wireless protocols, including Bluetooth, Bluetooth low energy (BLE), 802.11 compliant wireless local area network (WLAN), and/or any other wireless LAN protocol. The network may use networking protocols, for example Transmission Control Protocol and Internet Protocol (TCP/IP), Asynchronous Transfer Mode (ATM), asymmetric digital subscriber line (ADSL), and/or any other networking protocol. The network may comprise one or more routers, wireless routers, hubs, smart hubs, switches, smart switches, and/or any other type of networking equipment.

The apparatus 201 may comprise one or more input and/or output (I/O) devices such as 206 for receiving input from and/or providing output to a user and/or other devices (e.g., another apparatus 201), machines (e.g., an autonomous vehicle such as 105 of FIG. 1 herein), and/or the like. Exemplary I/O device(s) 206 of apparatus 201 may comprise one or more of: a touchscreen, a display, a keyboard, a keypad, a mouse, voice activated software using speakers and microphone, a printer, a touchpad, game controllers, haptic devices, and/or the like. Additionally or alternatively, one or more standalone devices communicating with processor(s) 202, e.g., via a network (not shown), may serve as I/O device(s) 206, for example, a mobile and/or stationary computing device such as a smart phone, a tablet computer, a laptop computer, a desktop computer, a wearable computer, and/or the like, running a suitable application program, may establish communication (e.g., cellular, network, short range wireless) with the processor(s) 202 using a communication interface (e.g., network interface, cellular interface, short range wireless network interface). A user (e.g., a driver, an operator, and/or the like) may input data and/or receive data outputted by the respective device, e.g., by entering and/or viewing data on a display of the computing device (e.g., a smart phone), optionally via a graphical user interface (GUI) application and/or the like.

The apparatus 201 may comprise a memory and/or data storage device such as 208, which may be configured to store code instructions executable by processor(s) 202, for example, a random access memory (RAM), a read-only memory (ROM), and/or a storage device, for example, a non-volatile memory, magnetic media, semiconductor memory devices, a hard drive, a removable storage, optical media (e.g., DVD, CD-ROM), and/or the like. The memory 208 may store code instructions that implement one or more acts of the method described with reference to FIG. 4 herein. Alternatively or additionally, one or more acts of the method described with reference to FIG. 4 herein may be implemented in hardware.

The memory 208 may comprise an implement control logic such as 210 which may be implemented as code instructions adapted to cause the processor(s) 202 when executed thereby to receive input via communication bus 203, network interface 204, I/O device(s) 206, and/or any likewise input receipt means of the apparatus 201, and determine control commands for operation of an implement coupled to an autonomous vehicle such as 105 of FIG. 1 herein. The control commands may be communicated to the autonomous vehicle via communication bus 203, network interface 204, I/O device(s) 206, and/or any likewise communication and/or output provision means of the apparatus 201.

The implement control logic 210 may be adapted to cause the processor(s) 202 when executed thereby to analyze the input received, which may include, for example, sensory data related to the implement and/or operation thereof by the autonomous vehicle, operational data of the autonomous vehicle, and/or the like, and to determine accordingly actions to be performed by the autonomous vehicle in operation of the implement, such as for example, modifying a motion vector of the autonomous vehicle, performing an actuation operation on the implement (e.g., activation/deactivation of mechanical, electrical, hydraulic, and/or any likewise operational mechanism of the implement, which may be controlled by respective actuators such as the actuator(s) 110, 113, and 117 as depicted on FIG. 1 herein), and/or the like. The implement control logic 210 may be adapted to cause the processor(s) 202 when executed thereby to generate control commands encoding instructions for performing the actions determined, where in response to receipt of such control commands, an autonomous vehicle being in communication with the apparatus 201 decodes and applies the instructions thereby performing the actions in operation of an implement coupled thereto.

In some embodiments, the implement control logic 210 may comprise one or more configurable implement parameters such as 215, such as for example, positioning and/or orientation of the implement relative to the autonomous vehicle and/or ground (e.g., a working height and/or the like), tolerance levels and/or ranges of values set for respective implement parameter(s), limits and/or threshold values for monitored aspects of the implement operation (e.g., RPM limits and/or the like), and/or any likewise implement operation parameters. The implement control logic 210 may be adapted to cause the processor(s) 202 when executed thereby to analyze input received and/or determine control commands in accordance with a configuration of the implement parameters 215 as may be received for example via the I/O device(s) 206 and/or network interface 204, stored in the memory 208, and/or the like.

In some embodiments, the memory 208 may comprise one or more implement specifications such 220 which may correspond to different types and/or models of implements adapted to be attached to an autonomous vehicle such as 105 of FIG. 1 herein. Optionally the implement control logic 210 may be configured with and/or utilize during execution thereof in operation of an implement a respective one of the implement specification(s) 220 for ensuring compliance therewith of the actions determined to be performed on the implement and/or with relation thereto by the autonomous vehicle.

In some embodiments, the apparatus 201 may comprise and/or be in communication with a data storage device (not shown) for storing data, for example, the implement specification(s) 220 and/or the like. The storage coupled to and/or otherwise accessible by the apparatus 201 may be implemented as, for example, a memory, a local hard-drive, a removable storage unit, an optical disk, a storage device, and/or as a remote server and/or computing cloud (e.g., accessed via a network connection).

In some embodiments, the apparatus 201 may be provided with a housing (not shown), such as a chassis and/or likewise enclosure. Optionally the housing may comprise a plurality of brackets for allowing installation and fitting thereof with different types and/or models of autonomous vehicles and/or implements. Additionally or alternatively, the apparatus 201 and/or housing thereof may be provided with an implement mount (not shown) allowing for mounting of the apparatus 201 on an implement coupled to autonomous vehicle for use in agriculture and/or any likewise mission.

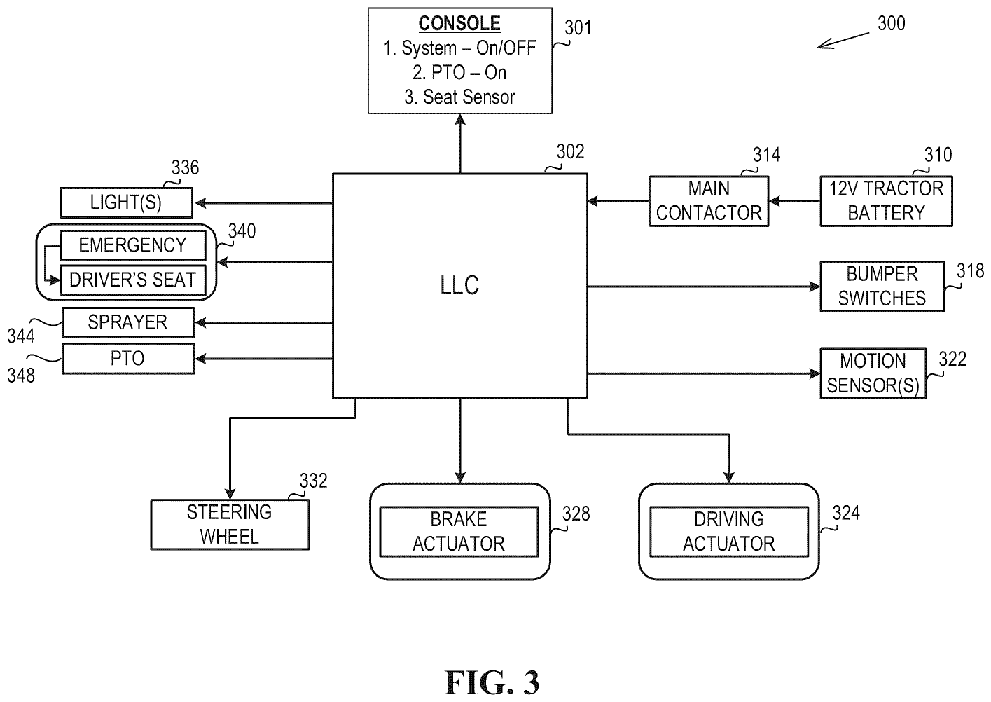

Reference is now made to FIG. 3 which is a schematic block diagram of an exemplary low level control wiring architecture for autonomous vehicle implement control, according to some embodiments.

A wiring architecture of low-level control of an autonomous vehicle (such as, for example, a tractor and/or the like) for controlling an implement, such as the exemplary architecture 300 as shown and illustrated on FIG. 3, may comprise a console such as 301, which may be coupled to a low-level controller (LLC) such as 302. The LLC 302 may be same component(s) as and/or similar to the LLC component(s) 102 of FIG. 1 herein.

As illustrated on FIG. 3, the console 301 may be adapted for switching on and/or off an autonomous vehicle implement control system such as one optionally having the exemplary architecture 100 illustrated on FIG. 1 herein, switching on power take off (PTO) engagement, operating a seat sensor for determining presence of a user (e.g., a driver, operator, and/or the like), and/or for any likewise control operations, effected manually and/or automatically, as described herein.

The architecture 300 may comprise a power supply, e.g., a 12 Volt tractor battery such as 310 and/or likewise energy source, which may be adapted for providing electrical current to the LLC 302 and/or other elements of the architecture 300, optionally via a main contactor such as 314 and/or the like. Optionally the 12V tractor battery 310 may be an electrical energy source as provided for powering the autonomous vehicle. Similarly, the LLC 302 may be controller of the autonomous vehicle as may be provided by an original equipment manufacture (OEM) and/or the like.

The architecture 300 may comprise one or more bumper switches such as 318 for operating respective bumper(s) of the autonomous vehicle and/or likewise safety aid(s) such as the implement bumper 136 of FIG. 1 herein, optionally in response to respective control command(s) from the LLC 302 received manually from an operator and/or automatically from an implement control module such as 101 of FIG. 1 and/or likewise apparatus such as 201 of FIG. 2.

The architecture 300 may comprise one or more position and/or motion sensors such as 322, e.g., linear variable inductive transducers (LVIT) and/or any likewise contactless sensory data generating technologies, which may be same as and/or similar to the position sensor(s) 130. Additionally or alternatively, motion sensor(s) 322 may include an accelerometer, a global positioning system (GPS) sensor, and/or the like. The motion sensor(s) 322 may be operated and/or controlled via respective control command(s) from the LLC 302, which may optionally be received from an implement control module such as 101 of FIG. 1 and/or apparatus such as 201 of FIG. 2, as described herein.

The architecture 300 may comprise a drive such as 324, which may optionally comprise, for example, a driving actuator and/or any other likewise drive elements such as depicted on FIG. 3. The drive 324 may similarly as the bumper switches 318 and/or the LVIT 322 be operated and/or controlled via respective control command(s) from the LLC 302, optionally received from an implement control module such as 101 of FIG. 1 and/or apparatus such as 201 of FIG. 2, as described herein.

The architecture 300 may comprise a brake system such as 328, which may optionally comprise, for example, a brake actuator and/or any other likewise braking elements such as depicted on FIG. 3, optionally operated and/or controlled via respective control command(s) from the LLC 302 such as described herein.

The architecture 300 may comprise a steering control, e.g., a steering wheel such as 332 and/or the like, adapted for redirection, reorientation, and/or likewise maneuvering of the autonomous vehicle, optionally operated and/or controlled via respective control command(s) from the LLC 302 as described herein.

The architecture 300 may comprise one or more light sources such as 336 and/or likewise illumination device, which may be for example a strobe and/or the like, optionally producing flashes of light at a high intensity and/or speed, and further optionally being operated and/or controlled via respective control command(s) from the LLC 302 such as described herein.

The architecture 300 may comprise protective measures such as 340 and/or the like, which may comprise, for example, an emergency button similarly as 139 of FIG. 1, being optionally coupled to a driver's seat at the autonomous vehicle, and being further optionally adapted for eliminating and/or mitigating imminent safety hazards and/or likewise issues related to operation of the autonomous vehicle and/or of an implement coupled thereto. The protective measures 340 may optionally be operated and/or controlled via respective control command(s) from the LLC 302 such as described herein.

The architecture 300 may comprise a sprayer such as 344 and/or the like, which may be adapted for spraying of agricultural crops and/or likewise missions, e.g., projection of water, weed killers and/or likewise herbicides, crop performance materials such as fertilizers and/or the like, pesticides and/or likewise pest maintenance chemicals, manufacturing and production line ingredients, and/or the like. The sprayer 344 may optionally be operated and/or controlled via respective control command(s) from the LLC 302 such as described herein.

The architecture 300 may comprise a power take off (PTO) unit and/or shaft such as 348 and/or the like, adapted for taking power from a running engine of the autonomous vehicle and transferring thereof to an attached implement and/or likewise separate machinery. The PTO 348 may optionally be operated and/or controlled via respective control command(s) from the LLC 302 such as described herein.

The architecture 300 may optionally comprise an electronic monitoring and/or signaling device such as a digital potentiometer and/or the like (not shown), adapted for indicating position status of an object being monitored, such as for example, a hitch height of a three-point lever of the autonomous vehicle (i.e., tractor) and/or the like. Such monitoring device may optionally be in communication and exchange data with the LLC 302, such as receive control command(s) therefrom and/or send sensory data thereto as described herein. Additionally or alternatively, such monitoring device may exchange data with an implement control module such as 101 of FIG. 1, and/or apparatus such as 201 of FIG. 2, via the LLC 302 and/or otherwise, as described herein.

Reference is now made to FIG. 4 which is a flowchart schematically representing an optional flow of operations for autonomous vehicle implement control, according to some embodiments. Such exemplary and/or optional operations as depicted on FIG. 4 may be performed by an implement control module such as 101 of FIG. 1, and/or apparatus such as 201 of FIG. 2, as described and illustrated herein.

At 400, an implement coupled to an autonomous vehicle and designated for a mission at hand may be configured, for example, respective values for configurable implement parameters as may be received from a user and/or otherwise obtained may be assigned. Additionally or alternatively, a type and/or a model of the implement and/or autonomous vehicle may be determined, e.g., via an identification procedure carried out automatically and/or manually. Optionally an implement specification such as 220 of FIG. 2 herein may be loaded and/or retrieved based on a result of the identification as part of the implement parameter(s) configuration process.

At 410, sensory data input from at least one sensor acquiring sensory data related to the implement and/or the autonomous vehicle may be received. The sensory data may be received and/or originate from one or more sensors and/or sensor types, which may include, for example, revolutions per minute (RPM) sensor(s), speed sensor(s), moment measurement sensor(s), heat sensor(s), orientation sensor(s), motion sensor(s), pressure sensor(s), volume sensor(s), electronics load sensor(s), electromagnetic imaging sensor(s), e.g., camera(s), light detection and ranging (LiDAR) sensor(s), radio detection and ranging (RADAR) sensor(s), and/or the like, acoustic imaging sensor(s), and/or the like. The sensor(s) may be deployed in an environment where the implement being operated at, mounted on the implement and/or the autonomous vehicle, and/or the like. The sensor(s) may comprise one or more sensor(s) such as 120, 124, 128, and/or 130 of FIG. 1 herein, and/or any other likewise sensor(s) adapted for acquiring sensory data related to the implement and/or operation thereof by the autonomous vehicle as described herein.

At 420, state data input relating to a state and/or status of the autonomous vehicle, such as, for example, a magnitude and/or direction of a motion vector thereof, a number of revolutions per minute (RPM) of an engine of the autonomous vehicle, and/or the like, may optionally be received.

At 430, the input received at 410 and/or 420 may be analyzed to determine one or more actions to be performed on the implement by the autonomous vehicle. Such action(s) may include, for example, modifying a motion vector of the autonomous vehicle, performing an actuation operation on the implement by the autonomous vehicle, e.g., using one or more actuators such as the actuator(s) 110, 113, and/or 117 of FIG. 1, and/or any likewise actuator(s), invoking one or more protective measures such as the safety aid(s) 136 and/or 139 of FIG. 1 and/or any likewise safety aid(s), and/or any other likewise actions for controlling operation of the implement by the autonomous vehicle.

At 440, an output of one or more control commands encoding respective instructions for performing by the autonomous vehicle the action(s) determined at 430 may be generated. The control command(s) so generated may be adapted to, in response to receipt and decoding thereof by the autonomous vehicle, cause the autonomous vehicle to perform the action(s) on the implement thereby controlling operation thereof. Optionally, the control command(s) generated at 440 may be adapted to be transmitted to and/or processed by one or more LLC/HLC component(s) of the autonomous vehicle, such as 102 of FIGS. 1 and/or 302 of FIG. 3 herein.

At 450, the control command(s) output as generated at 440 may be communicated to the autonomous vehicle for being executed thereby in order of operating the implement and/or otherwise controlling operation thereof. Such control command(s) may include for example actuation command(s) such as in 452, motion command(s) such as 454, safety command(s) such as in 456, and/or the like. Optionally the safety command(s) at 456 may overlap with and/or include a subset of the actuation command(s) of 452 and/or the motion command(s) 454. As shown on FIG. 4, the process may be performed repeatedly over a plurality of iterations from 410 through to 450 until mission completion and/or the like.

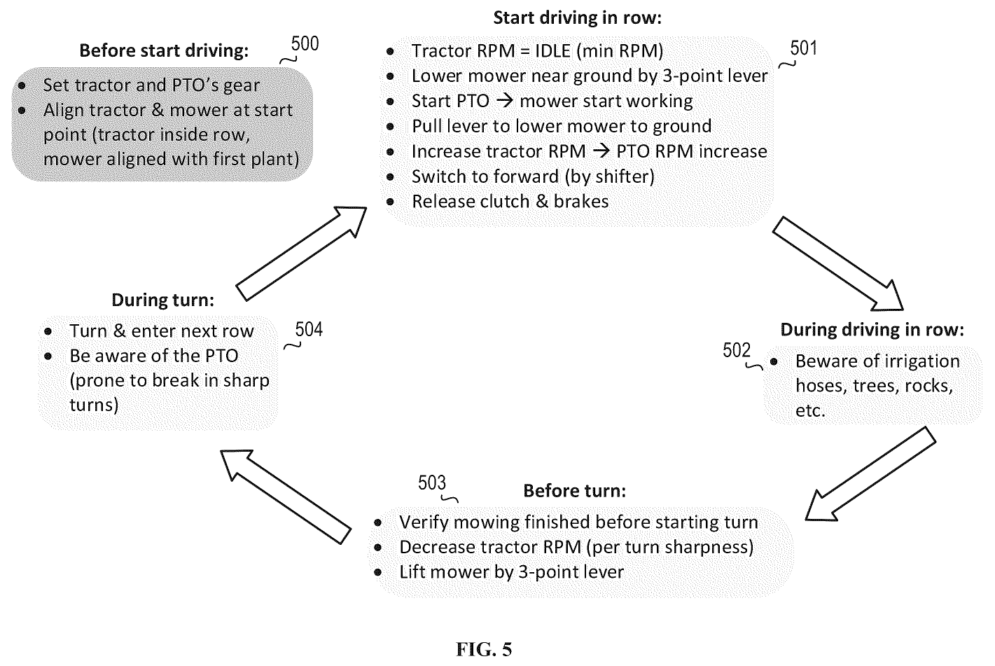

Reference is now made to FIG. 5 which is a sequence diagram of an optional flow of operations in an exemplary illustrative use case of utilizing autonomous vehicle implement control, according to some embodiments.

In the exemplary illustrative use case where the disclosed subject matter may be utilized such as depicted on FIG. 5, an autonomous vehicle adapted for use in agriculture such as for example a tractor and/or the like may be coupled to an implement similarly adapted for agricultural usage such as for example a mower and/or the like, which in conjunction with one another may be used for performing a mowing mission in an environment such as a field where plants of crops and/or other vegetation may be grown and/or cultivated.

Accordingly, one objective of the disclosed subject matter in such use case may be providing an ability to operate the tractor for performing the mowing mission, including for example controlling of a hitch height of a three-point lever thereby controlling a height of the mower above ground, controlling engagement of a power take off (PTO) unit thereby transferring power from the tractor's engine to the mower, providing feedback and/or information relating to operation of the implement to a controller adapted for operating the tractor, such as an implement control module such as 101 of FIG. 1, and/or apparatus such as 201 of FIG. 2, including for example shaft load, revolutions per minute (RPM), position, and/or the like, optionally as may be acquired by respective sensor(s) monitoring the mower and/or tractor, and/or any other likewise required functionality for carrying out the task at hand.

The mower may be adapted for being powered via a PTO unit of a tractor and/or likewise autonomous vehicle adapted for use in agriculture. During operation and/or working in the environment, the mower may be required for being straightly driven by the tractor, raised for purpose of turning, e.g., to the left and/or right, and/or the like. Optionally in some embodiments and/or for some models, the mower may be used in conjunction with auxiliary wheels, e.g., height wheels for additional lift above ground and/or the like.

In some embodiments, mission requirements for the mower may include for example one or more specified parameters, variables, attributes, and/or likewise operation principles of the mower, such as for example, limits, tolerance levels, conditions, contingencies, failures, and/or the like, relating to features and/or functionalities of the mower such as for example, linear speed, revolutions per minute (RPM), height, position relative to crops and/or plants in the working environment, e.g., threshold distance from a row of crop plants, and/or the like.

As an illustrative example, with regard to a RPM variable, one mission requirement may be, e.g., monitoring a value of the RPM and in case of the value dropping down below a respective threshold the mower may be required to be raised by the tractor for ensuring RPM recovery and/or the like. Optionally, an event of raising the mower, e.g., due to RPM level drop, may be marked and/or otherwise recorded at the implement control module and dealt with accordingly.

As another illustrative example, with regard to a speed variable, one mission requirement may be, e.g., monitoring a value of the speed and in case of the value exceeding a respective threshold the mower may be required to decelerate by way of the tractor decelerating and/or power take off decreasing a level of energy transferred to the mower, so as to avoid a result of poor cutting due to overly fast driving of the mower and/or tractor.

In some embodiments, one or more limitations of the mower may be specified, such as for example mower limitations including limits on height, relative position in a row (i.e., a spacing from plants of crops grown in the working environment), power take off (PTO) engagement, and/or the like. For example, mower limitations with regard to height thereof may include, e.g., requirement that the mower be positioned in a hover-like state above ground during operation. Additionally or alternatively, in case of a back wheel being provided for the mower, the three-point hitch lever of the tractor coupled to the mower may be lowered all the way down. Another exemplary mower limitation on height may arise due to operating PTO limits optionally limiting an upper height of an upper hitch point, for example, due to loads on U-shaped joints thereof and/or the like. Exemplary mower limitations with regard to position in and/or relative a row may relate to a width of the mower, which may be at least as wide as the tractor and/or wider than the tractor in some embodiments. Exemplary mower limitations with regard to PTO engagement may include, e.g., maximum revolutions per minute (RPM) of the tractor's engine for engagement and/or the like. In some embodiments, disengagement of PTO may be performed at any time without limit.

In some embodiments, one or more contingencies of the mower may be specified, such as for example including with relation to revolutions per minute (RPM) drop of the tractor's engine and/or the mower, a height of the mower, sensory data related to the mower, e.g., from lateral sensor mounted thereon for monitoring position thereof relative to a working row, and/or the like. For example, mower contingencies with relation to engine RPM drop may include raising hitch height of the mower (e.g., by raising the three-point hitch lever), switching operation of the engine to neutral mode, and/or the like. Exemplary mower contingencies with relation to mower RPM drop may include determination of whether the mower RPM drop being correlated with an engine RPM drop, where in case of determination to the negative, then an alert indicating a malfunction (e.g., drive line failure and/or the like) may be outputted to a user and/or the like. Exemplary mower contingencies with relation to a height of the mower may include determination of whether the height not being changed in response control commands for raising and/or lowering the three-point hitch lever of the tractor, where in case of determination to the affirmative, then an alert indicating a hitch failure and/or the like may be outputted. Exemplary mower contingencies with relation to sensory data such as from a lateral sensor of the mower may include providing warning where a lateral distance of the mower from a row falls below a threshold and/or caution where an orientation of the mower and/or tractor deviating from a set path, where in response to such indication, operation and/or driving of the mower by the tractor may be stopped and/or the tractor's path may be corrected accordingly.

In some embodiments, one or more failure states of the mower may be specified, such as for example including failures related to undesired interactions with irrigation pipes which may be deployed in the working environment, e.g., the mower may accidentally collect and destroy such pipes in a matter of few seconds. In such occurrence, the load on the engine of the tractor may raise and the engine may starve as result. Moreover, recovery from such failure may not be achieved merely by raising the hitch. Other exemplary mower failures may be related to hitting the ground and/or other objects such as rocks, trees, and/or the like. Such hits may create adverse impact on the drive line, cause failure of decoupler and/or belt of the tractor's drive, and/or the like. Yet other exemplary mower failures may be related to a height thereof, such as including the mower being positioned too high above ground and as result failing mission of cutting grass. Optionally the height of the mower may be visually checked and corrected accordingly.

Additionally or alternatively, one or more mower safety considerations may be specified, such as for example, PTO catching prevention, hitch related concerns such as unintentional movement, dependence on hydraulic pressure as provided by the tractor, start up and shut down of the tractor, and/or the like, final drive related aspects and/or hazards such as flying rocks, flying parts, drive line, and/or the like, as well as any other likewise mower safety parameters.

In some embodiments, implications of the mower on a path of the tractor may include for example implications such as being related to the three-point implement hitch adapter, e.g., an added length of the mower relative to an individual length of the tractor, steering effects, e.g., when the tractor steers to the right the mower goes to the left and vice versa, and/or the like. Exemplary implications related to operating position of the mower may include limits on a steering rate, possible braking of the hitch caused due to steering while the mower being down, and/or the like. Exemplary implications related to start of row where the mower being worked at may include a minimum time duration which may take for lowering the hitch, where such lowering time may be required to be taken into account and/or consideration in respective operating command(s), and/or the like.

In some embodiments, one or more mower parameters may be specified such as, for example, final drive RPM, optionally including lower limit, upper limit, and/or the like, height parameters such as target height, turning height, taxi height, height limit during PTO operation, hitch raising/lowering speed and/or tolerance, height of lateral sensor(s), e.g., left sensor, right sensor, and/or the like, lateral position parameters such as left sensor reading, right sensor reading, warning limit, caution limit, and/or the like, a hitch type parameter, e.g., electrical, digital, and/or the like, a mower type parameter, e.g., bush hog, flail, and/or the like, mower dimensions, e.g., width, length, and/or the like, parameters relating to availability of features and/or functionalities such as back wheel, mower bumper, emergency button, and/or the like, and/or any other likewise mower parameters. Optionally the mower parameters and/or at least a portion thereof may be required to undergo a calibration process prior to operation of the mower by the tractor in accordance with the disclosed subject matter.

In some embodiments, an implement control module in accordance with the disclosed subject matter may be having capabilities such as including preset height of the implement (i.e., mower) for working, turning, raising up, and/or the like, a control logic comprising one or more rules for operation of the implement such as height relative to the ground, PTO load control, position feedback, and/or the like. Optionally such rules may be developed, extended, refined, and/or the like using information gathered during operation, e.g., using machine learning (ML), artificial intelligence (AI), and/or likewise tools and/or techniques.

Referring back to FIG. 5, operation of a mower by a tractor capable of autonomous driving utilizing an implement control module as disclosed herein may comprise at 500 before driving of the tractor being started one or more actions such as setting the tractor and PTO's gear, aligning the tractor and/or the mower at a start point, e.g., where the tractor being located inside a row, the mower being aligned with a first plant of the row, and/or the like.

At 501 where driving of the tractor with the mower being attached thereto in the row may be started, there may be performed one or more respective actions such as setting the tractor's engine RPM to idle and/or minimum RPM level, lowering the mower near ground by the three-point hitch lever of the tractor, engage and start PTO to cause the mower to start working, pulling the three-point hitch lever to lower the mower towards the ground, increasing the tractor's engine RPM level to cause the PTO RPM level to increase as well, switching to forward drive of the tractor (e.g., by a shifter and/or the like), releasing the tractor's clutch and/or brakes, and/or the like.

At 502 during driving of the tractor and mower in the row, there may be performed one or more respective actions such as monitoring for objects and/or hazards such as detecting and avoiding of irrigation hoses, trees, rocks, and/or the like.

At 503 before turning of the tractor and/or coupled mower, e.g., for exiting a current row and entering a next one, one or more respective actions may be performed such as verifying mowing in the row being finished before starting turning, decreasing the tractor's engine RPM level which may optionally be in accordance with a sharpness of the turn, lifting the mower by the three-point hitch lever of the tractor, and/or the like

At 504 during turning of the tractor and/or coupled mower, one or more respective actions may be performed such as turning to enter the next row, monitoring status of the PTO for risk of breaking thereof in sharp turns, and/or the like. The process may then continue back at 501 and through to 504 repeatedly for a plurality of iterations until the mowing mission being completed and/or the like.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant autonomous vehicle implement control tools and/or techniques will be developed and the scope of the term autonomous vehicle implement control is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment may include a plurality of “optional” features unless such features conflict.

Throughout this application, various embodiments may be presented in a range format. It should be understood that the description in range format is merely for convenience and brevity and should not be construed as an inflexible limitation on the scope of embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of embodiments, which are, for clarity, described in the context of separate embodiments, may also be provided in combination in a single embodiment. Conversely, various features of embodiments, which are, for brevity, described in the context of a single embodiment, may also be provided separately or in any suitable subcombination or as suitable in any other described embodiment. Certain features described in the context of various embodiments are not to be considered essential features of those embodiments, unless the embodiment is inoperative without those elements.

Although embodiments have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of controlling an autonomous vehicle coupled to an implement adapted for agricultural use, the method comprising:
by at least one processing circuitry of a device adapted to be in communication with an autonomous vehicle coupled to an implement, executing code for:
receiving sensory data relating to the implement acquired by at least one sensor deployed in an environment of the implement and configured for operating during working of the implement in the environment;
determining, based on analyzing the sensory data, at least one of:
instructions to modify a motion vector of the autonomous vehicle, and
instructions to perform an actuation operation on the implement by the autonomous vehicle;
generating at least one control command encoding the instructions; and
communicating the at least one control command to the autonomous vehicle,
wherein the autonomous vehicle applying the instructions in response to the at least one control command.

2. The method of claim 1, wherein the analyzing the sensory data comprising determining at least one event related to the implement and at least one action required in response to the at least one event.

3. The method of claim 1, wherein the at least one sensor being selected from the group consisting of: a revolutions per minute sensor; a speed sensor; a moment measurement sensor; a heat sensor; an orientation sensor; a motion sensor; a pressure sensor; a volume sensor; an electronics load sensor; an electromagnetic imaging sensor; an acoustic imaging sensor.

4. The method of claim 1, wherein the instructions to modify the motion vector of the autonomous vehicle comprising at least one action by a controller of the autonomous vehicle selected from: start driving the autonomous vehicle; accelerate engine of the autonomous vehicle; decelerate engine of the autonomous vehicle; switch direction of motion of the autonomous vehicle to at least one of forwards and backwards; turn the autonomous vehicle to a specified direction; operate a braking system of the vehicle; stop the autonomous vehicle at a specified location in the environment; and move the autonomous vehicle in a specified trajectory.

5. The method of claim 1, wherein the instructions to perform the actuation operation on the implement by the autonomous vehicle comprising at least one member selected from: engage a power take off between the autonomous vehicle and the implement; disengage a power take off between the autonomous vehicle and the implement; lower a three-point hitch adapter coupling the autonomous vehicle and the implement to a specified height relative to the autonomous vehicle; raise a three-point hitch adapter coupling the autonomous vehicle and the implement to a specified height relative to the vehicle; decrease a revolutions per minute energy level of the implement; increase a revolutions per minute energy level of the implement; modify at least one of a direction, a flow, and a pressure of at least one of a plurality of hydraulics channels connected to the implement; and operate an electric energy supply to the implement.

6. The method of claim 1, further comprising performing, by the at least one processing circuitry, executing code for: receiving, over a communication channel established between the device and the autonomous vehicle, operational data relating to operation of the autonomous vehicle during working of the implement in the environment; and, analyzing the operational data further to the sensory data in determining the at least one of the instructions.

7. The method of claim 1, wherein the determining the at least one of the instructions being performed in compliance with a specification of the implement.

8. The method of claim 1, further comprising performing, by the at least one processing circuitry, executing code for: identifying a type of at least one of the autonomous vehicle and the implement; and, configuring the analyzing of the sensory data and the determining the at least one of the instructions in accordance with the type identified.

9. The method of claim 1, further comprising performing, by the at least one processing circuitry, executing code for: receiving at least one parameter value of at least one configurable parameter of the implement; and, setting the at least one configurable parameter respective of the at least one parameter value received, wherein the determining the at least one of the instructions being performed in accordance with the at least one parameter value set for the at least one configurable parameter.

10. The method of claim 1, further comprising performing, by the at least one processing circuitry, executing code for: determining, based on analyzing the sensory data, whether at least one alert condition being met; and, outputting at least one respective alert to a user in response to determining the at least one alert condition being met.

11. The method of claim 1, wherein the autonomous vehicle is an agricultural vehicle.

12. The method of claim 1, wherein the autonomous vehicle is a tractor.

13. The method of claim 1, wherein the implement is an agricultural implement to be connected to a tractor.

14. The method of claim 1, wherein a plurality of implements comprising the implement are coupled to the autonomous vehicle and connected to one another into a single working unit.

15. A device for controlling an autonomous vehicle coupled to an implement adapted for agricultural use, comprising:
a communication interface adapted for communication with an autonomous vehicle coupled to an implement;
at least one processing circuitry adapted to execute code for:
receiving sensory data relating to the implement acquired by at least one sensor deployed in an environment of the implement and configured for operating during working of the implement in the environment;
determining, based on analyzing the sensory data, at least one of:
instructions to modify a motion vector of the autonomous vehicle, and
instructions to perform an actuation operation on the implement by the autonomous vehicle;
generating at least one control command encoding the instructions; and
communicating the at least one control command to the autonomous vehicle, wherein the autonomous vehicle applying the instructions in response to the at least one control command.

16. The device of claim 15, further comprising an implement mount for mounting the device on the implement.

17. The device of claim 15, further comprising a plurality of brackets for fitting the device to different models of autonomous vehicles.

18. The device of claim 15, further comprising a data bus adapted for connection to and receipt of data from the implement.

19. The device of claim 15, further comprising a plurality of relays adapted for communication with a low-level controller of the autonomous vehicle.

20. A computer program product for controlling an autonomous vehicle coupled to an implement adapted for agricultural use, comprising:
a non-transitory computer readable storage medium;
program instructions for executing, by a processing circuitry of a device adapted to be in communication with an autonomous vehicle coupled to an implement:
receiving sensory data relating to the implement acquired by at least one sensor deployed in an environment of the implement and configured for operating during working of the implement in the environment;
determining, based on analyzing the sensory data, at least one of:
instructions to modify a motion vector of the autonomous vehicle, and
instructions to perform an actuation operation on the implement by the autonomous vehicle;
generating at least one control command encoding the instructions; and
communicating the at least one control command to the autonomous vehicle, wherein the autonomous vehicle applying the instructions in response to the at least one control command.
